(19) United States
(12) Patent Application Publication
(10) Pub. No.: US 2024/0184503 A1
(43) Pub. Date: Jun. 6, 2024

(54) OVERLAYING AN IMAGE OF A CONFERENCE CALL PARTICIPANT WITH A SHARED DOCUMENT

(71) Applicant: Google LLC, Mountain View, CA (US)

(72) Inventors: Alexander H. Rothera, San Francisco, CA (US); Lisa Takehana, San Bruno, CA (US)

(21) Appl. No.: 18/438,323

(22) Filed: Feb. 9, 2024

Related U.S. Application Data
(63) Continuation of application No. 17/549,708, filed on Dec. 13, 2021.
(60) Provisional application No. 63/192,509, filed on May 24, 2021.

(51) Int. Cl. G06F 3/14; G06T 3/40; G06T 7/90; G06T 11/60; H04M 3/56; H04N 5/272

(52) U.S. Cl. CPC G06F 3/1454; G06T 3/40; G06T 7/90; G06T 11/60; H04M 3/563; G06T 2200/24; G06T 2207/30176; G06T 2210/62; H04N 5/272

(57) ABSTRACT

A request is received to initiate an operation to share a first document displayed via a first graphical user interface (GUI) on a first client device of a first participant of a conference call with a second participant of the conference call via a second GUI on a second client device. Image data depicting the first participant during the conference call is fed as input to a model. A second document including second content corresponding to first content of the first document is obtained based on an output of the model. One or more regions of the second document satisfy an image placement criterion. The second document and a portion of the image data depicting the first participant is provided during the conference call for presentation in at least one of the one or more regions of the second document via the second GUI on the second client device.

### RELATED APPLICATIONS

This continuation application claims priority to U.S. patent application Ser. No. 17/549,708 filed on Dec. 13, 2021 and entitled “OVERLAYING AN IMAGE OF A CONFERENCE CALL PARTICIPANT WITH A SHARED DOCUMENT,” which claims priority to U.S. Provisional Patent Application No. 63/192,509 filed on May 24, 2021 and entitled “OVERLAYING AN IMAGE OF A CONFERENCE CALL PARTICIPANT WITH A SHARED DOCUMENT,” which is incorporated by reference herein.

### TECHNICAL FIELD

Aspects and implementations of the present disclosure relate to overlaying an image of a conference call participant with a shared document.

### BACKGROUND

Video or audio-based conference call discussions can take place between multiple participants via a conference platform. A conference platform includes tools that allow multiple client devices to be connected over a network and share each other's audio data (e.g., voice of a user recorded via a microphone of a client device) and/or video data (e.g., a video captured by a camera of a client device, or video captured from a screen image of the client device) for efficient communication. A conference platform can also include tools to allow a participant of a conference call to share a document displayed via user interface (UI) on a client device associated with the participant with other participants of the conference call.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for overlaying an image of a conference call participant with a shared document. In an implementation, a request is received to initiate a document sharing operation to share a document displayed via a first graphical user interface (GUI) on a first client device associated with a first participant of a conference call with a second participant of the conference call via a second GUI on a second client device. Image data corresponding to a view of the first participant in a surrounding environment is also received. An image depicting the first participant is obtained based on the received image data. One or more regions of the document that satisfy one or more image placement criteria are identified. The document and the image depicting the first participant are provided for presentation via the second GUI on the second client device. The image depicting the first participant is presented at a region of the identified one of more regions of the document.

In some implementations, another system and method are disclosed for overlaying an image of a conference call participant with a shared document. In an implementation, a document displayed via a first graphical user interface (GUI) on a first client device associated with a first participant of a conference call is shared with a second participant of the conference call via a second GUI on a second client device. A request is received to display an image depicting the first participant of the conference call with the document shared with the second participant via the second GUI. Image data corresponding to a view of the first participant in a surrounding environment is received. An image depicting the first participant is obtained based on the received image data. At least one of a formatting or an orientation of one or more content items of the shared document is modified in view of the image depicting the first participant. The image depicting the first participant with the modified document is provided for presentation via the second GUI on the second client device.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram illustrating an example conference platform and an example background extraction engine, in accordance with implementations of the present disclosure.

FIG. 3 is a block diagram illustrating an example conference platform and an example image overlay engine, in accordance with implementations of the present disclosure.

FIG. 4 depicts a flow diagram of an example method for overlaying an image of a conference call participant with a shared document, in accordance with implementations of the present disclosure.

FIGS. 5A-5C illustrate an example of overlaying an image of a conference call participant with a shared document for presentation via a GUI, in accordance with implementations of the present disclosure.

FIGS. 6A-6C illustrate another example of overlaying an image of a conference call participant with a shared document for presentation via a GUI, in accordance with implementations of the present disclosure.

FIG. 7 depicts a flow diagram of another example method for overlaying an image of a conference call participant with a shared document, in accordance with implementations of the present disclosure.

FIGS. 8A-8B illustrate another example of overlaying an image of a conference call participant with a shared document for presentation via a GUI, in accordance with implementations of the present disclosure.

FIGS. 9A-9B illustrate an example of overlaying an image of multiple conference call participants with a shared document for presentation via a GUI, in accordance with implementations of the present disclosure.

FIG. 10 is a block diagram illustrating an exemplary computer system, in accordance with implementations of the present disclosure.

### DETAILED DESCRIPTION

Aspects of the present disclosure relate to overlaying an image of a conference call participant with a shared document. A conference platform can enable video or audio-based conference call discussions between multiple participants via respective client devices that are connected over a network and share each other's audio data (e.g., voice of a user recorded via a microphone of a client device) and/or video data (e.g., a video captured by a camera of a client device) during a conference call. In some instances, a conference platform can enable a significant number of client devices (e.g., up to one hundred or more client devices) to be connected via the conference call.

It can be overwhelming for a participant of a live conference call (e.g., a video conference call) to engage other participants of the conference call using a shared document (e.g., a slide presentation document, a word processing document, a webpage document, etc.). For example, a presenter of a conference call can prepare a document including content that the presenter plans to discuss during the conference call. Existing conference platforms enable the presenter to share the document displayed via a GUI of a client device associated with the presenter with the other participants of the call via a conference platform GUI on respective client devices while the presenter discusses content included in the shared document. However, such conference platforms do not effectively display the content of the shared document while simultaneously displaying an image depicting the presenter via the conference platform GUI on the client devices associated with the other participants. For example, some existing conference platforms may not provide the image depicting the conference call presenter with the document shared via the conference platform GUI, which prevents the presenter from effectively engaging with the participants via a video feature of the conference platform. As a result, the attention of the conference call participants is not captured for long (or at all) and the presentation of the shared document during the conference call can come across as being impersonal or mechanical. Other existing conference platforms may display the content of the shared document via a first portion of the conference platform GUI and an image depicting the presenter via a second portion of the conference platform GUI. However, given that the image of the presenter is displayed in a separate portion of the conference platform GUI than the content of the shared document, participants may not be able to simultaneously focus on or concurrently observe the visual cues or gestures provided by the presenter while consuming the content provided by the shared document.

Hardware constraints associated with different client devices connected to the conference call platform may prevent a conference platform GUI from displaying both the content of the shared document and the image of the presenter concurrently or effectively. Existing conference platforms do not provide mechanisms that can modify a display of a conference platform GUI on a client device associated with a participant of a conference call in view of one or more hardware constraints associated with the client device. In an illustrative example, a client device associated with a presenter of a conference call can include a large display screen. Client devices associated with some participants of the conference call can include a large display screen, while client devices associated with other participants of the call can include a small display screen. Existing conference platforms can provide the same document for presentation via the conference platform GUI at each client device regardless of the size of the display screen at the respective client device. Accordingly, participants accessing the conference call via client devices that include small display screens may not easily be able to consume all of the content of the document shared by the presenter. As a result, the presenter may not be able to effectively engage with these participants during the conference call.

Aspects of the present disclosure address the above and other deficiencies by providing techniques for layering an image of a conference call presenter with a document shared via a conference platform GUI on client devices associated with participants of the conference call. A client device associated with a presenter of a conference call can transmit a request to a conference platform to initiate a document sharing operation to share a document displayed via a GUI for the client device with participants of the conference call via GUIs on client devices associated with participants of the conference call. In addition or in response to receiving the request to initiate the document sharing operation, the conference platform can receive image data (e.g., pixel data, etc.) from the client device associated with the conference call presenter. The image data can correspond to a view of the first participant in a surrounding environment (e.g., a background environment). The conference platform can obtain an image depicting the presenter based on the received image data. For example, the received image data can include a first set of pixels associated with the presenter and a second set of pixels associated with the surrounding environment. The conference platform can extract the identified first set of pixels from the received image data and generate the image depicting the first participant based on the extracted first set of pixels.

In some embodiments, the conference platform can identify one or more regions of the document that satisfy one or more image placement criteria. In one example, a region of the document can satisfy the image placement criterion if the region of the document does not include any content or does not include content that is relevant to the presentation (e.g., the region includes a company logo, etc.). In other or similar embodiments, the conference platform can modify a formatting or an orientation of one or more content items of the shared document in order to accommodate the image depicting the presenter. For example, if a size of a title for a slide of a slide presentation document is large and takes up a significant amount of space in the conference platform GUI, the conference platform can reduce the size of the title or can move a portion of the title to another region of the slide in order to accommodate the image depicting the presenter. The conference platform can provide the document and the image depicting the presenter for presentation via the conference GUI on the client devices associated with the conference participants. The image depicting the presenter can be displayed at a region that was previously identified (or modified) to satisfy one or more image placement criteria.

A technical solution to the above identified technical problems of the conventional technology may include overlaying an image of a conference call presenter with a document shared via a conference platform GUI on client devices associated with participants of the conference call. In some embodiments, the conference platform may identify one or more regions of a document that satisfy one or more placement criteria (e.g., the one or more regions do not include content, etc.) for presentation of an image depicting the presenter of the conference call. In other or similar embodiments, the conference platform may modify one or more content items of the document to accommodate the image depicting the conference call presenter. Thus, the image depicting the conference call presenter is presented in a region of the shared document that does not interfere (or minimally interferes) with existing content of the document.

Another technical solution to the above identified technical problems is to modify the presentation of the document and the image depicting the presenter via the conference platform GUI on a particular client device in view of one of more hardware constraints associated with a client device. The conference platform can obtain data indicating one or more hardware constraints (e.g., an image resolution constraint, a screen size, etc.) associated with a client device associated with a conference call participant. If the one or more hardware constraints satisfy a hardware constraint criterion (e.g., fall below a threshold image resolution, a threshold screen size, etc.), the conference platform can modify the presentation of the document and the image depicting the presenter in view of the one or more hardware constraints. For example, the conference platform can present a first portion of content included in the document with the image depicting the presenter via the conference platform GUI. In response to detecting that the presenter has shifted focus of the presentation to the second portion of content, the conference platform can update the conference platform GUI at the client device to display the second portion of content included in the document with the image depicting the platform.

Thus, the technical effect may include improving the presentation of an image of a conference call presenter and a document shared with participants of the conference call. By providing mechanisms to present an image of the conference call presenter in a region that does not interfere (or minimally interferes) with existing content of a shared document, all important information is presented to the participants of the conference call in an unobstructed and convenient manner, while imitating an in-person meeting experience which enables the presenter to effectively engage with the participants of the conference call. In addition, by modifying a conference platform GUI in view of the hardware constraints (e.g., image resolution constraint, display screen size, etc.) for a client device associated with a conference call participant, both the conference call presenter image and the shared document can be presented to the participant in a format that is compatible with the hardware constraints (e.g., such that all the content is shown on the limited screen of the participant's device). Accordingly, the participant associated with the client device is able to consume all of the content included in the document as well as the image depicting the presenter and, the presenter of the conference call is able to effectively engage with that participant via the modified conference platform GUI.

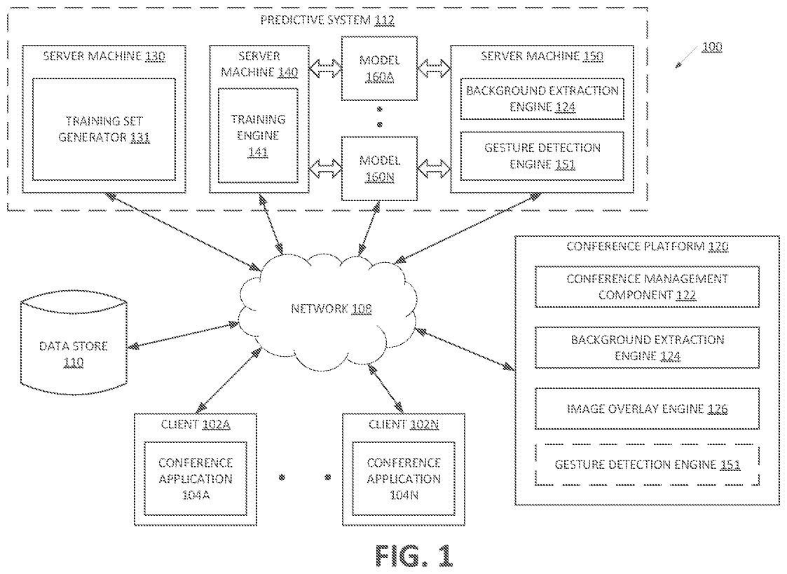

FIG. 1 illustrates an example system architecture 100, in accordance with implementations of the present disclosure. The system architecture 100 (also referred to as “system” herein) includes client devices 102A-N, a data store 110 and a conference platform 120, each connected to a network 108. In some embodiments, system 100 can additionally include a predictive system 112. Predictive system 112 can include one or more server machines 130-150 each connected to network 108.

In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data item can include audio data and/or image data, in accordance with embodiments described herein. In other or similar embodiments, a data item can correspond to a document displayed via a graphical user interface (GUI) on a client device 102, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by conference platform 120 or one or more different machines coupled to the conference platform 120 via network 108.

Conference platform 120 can enable users of client devices 102A-N to connect with each other via a conference call, such as a video conference call or an audio conference call. A conference call refers to an audio-based call and/or a video-based call in which participants of the call can connect with multiple additional participants. Conference platform 120 can allow a user to join and participate in a video conference call and/or an audio conference call with other users of the platform. Although embodiments of the present disclosure refer to multiple participants (e.g., 3 or more) connecting via a conference call, it should be noted that embodiments of the present disclosure can be implemented with any number of participants connecting via the conference call (e.g., 2 or more).

The client devices 102A-N can each include computing devices such as personal computers (PCs), laptops, mobile phones, smart phones, tablet computers, netbook computers, network-connected televisions, etc. In some implementations, client devices 102A-N may also be referred to as “user devices.” Each client device 102A-N can include a web browser and/or a client application (e.g., a mobile application or a desktop application). In some implementations, the web browser and/or the client application can display a user interface (UI), provided by conference platform 120, for users to access conference platform 120. For example, a user can join and participate in a video conference call or an audio conference call via a UI provided by conference platform 120 and presented by the web browser or client application.

Each client device 102A-N can include one or more audiovisual components that can generate audio and/or image data to be streamed to conference platform 120. In some implementations, an audiovisual component can include a device (e.g., a camera) that is configured to capture images and generate image data associated with the captured images. For example, a camera for a client device 102 can capture images of a participant of a conference call in a surrounding environment (e.g., a background) during the conference call. In additional or alternative implementations, an audiovisual component can include a device (e.g., a microphone) to capture an audio signal representing speech of a user and generate audio data (e.g., an audio file) based on the captured audio signal. The audiovisual component can include another device (e.g., a speaker) to output audio data to a user associated with a particular client device 102A-N.

In some implementations, conference platform 120 can include a conference management component 122. Conference management component 122 is configured to manage a conference call between multiple users of conference platform 120. In some implementations, conference management component 122 can provide a GUI to each client device (referred to as conference platform GUI herein) to enable users to watch and listen to each other during a conference call. In some embodiments, conference management component 122 can also enable users to share documents (e.g., a slide presentation document, a word processing document, a webpage document, etc.) displayed via a GUI on an associated client device with other users. For example, during a conference call, conference management component 122 can receive a request to share a document displayed via a GUI on a first client device associated with a first participant of the conference call with other participants of the conference call. Conference management platform 122 can modify the conference platform GUI at the client devices 102 associated with the other conference call participants to display at least a portion of the shared document, in some embodiments.

In some embodiments, conference management component 122 can overlay an image depicting a participant of a conference call with a document shared by the participant and present the shared document with the overlayed image to other participants via a conference platform GUI on client devices associated with the other participants. For example, a participant of a conference call can prepare a document (e.g., a slide presentation document) to present to other participants of the conference call. Such participant is referred to as a presenter, in some embodiments. Conference management component 122 can receive a request from a client device 102 associated with the presenter to share the document with the other conference call participants via the conference platform GUI on respective client devices 102 associated with the other conference call participants. In some embodiments, conference management component 122 can also receive an additional request to overlay an image depicting the presenter with the shared document.

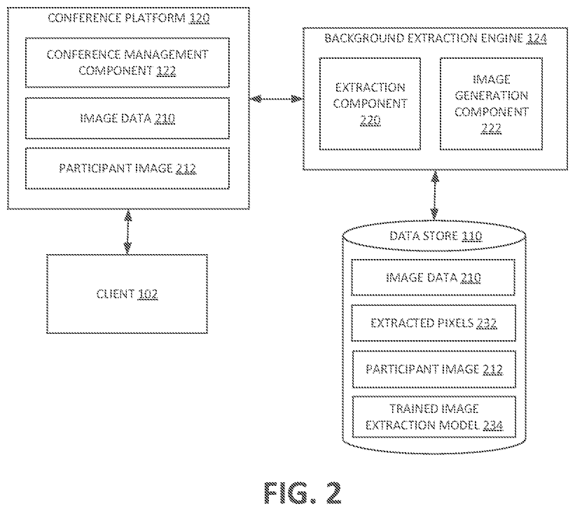

In response to receiving the one or more requests from the client device 102 associated with the presenter, conference management component 122 can obtain an image depicting the presenter. As described previously, an audiovisual component of each client device 102A-N can capture images and generate image data associated with the captured images. A camera for the client device 102 associated with the presenter can capture images of the presenter in a surrounding environment and generate image data associated with the captured images. In some embodiments, conference management component 122 can receive the image data generated by the client device 102 associated with the presenter and can obtain the image depicting the presenter from the received image data. In some embodiments, conference management component 122 can provide the image data received from the client device 102 associated with the presenter to a background extraction engine 124. In some embodiments, background extraction engine 124 can be configured to parse through image data and identify a portion of the image data that corresponds to a participant of a conference call and a portion of the image data that corresponds to an environment surrounding the participant. For example, in some embodiments, the image data received from the client device 102 associated with the presenter can include a first set of pixels associated with the presenter and a second set of pixels associated with the surrounding environment. Background extraction engine 124 can parse through the received image data to identify the first set of pixels associated with the presenter and can extract the first set of pixels from the image data. In other or similar embodiments, background extraction engine 124 can be configured to identify a portion of the image data that corresponds to the conference call participant based on one or more outputs of a machine learning model, in accordance with embodiments described below. Conference management component 122 and/or background extraction engine 124 can generate the image depicting the presenter based on the extracted first set of pixels. Further details regarding background extraction engine 124 are provided below and with respect to FIG. 2.

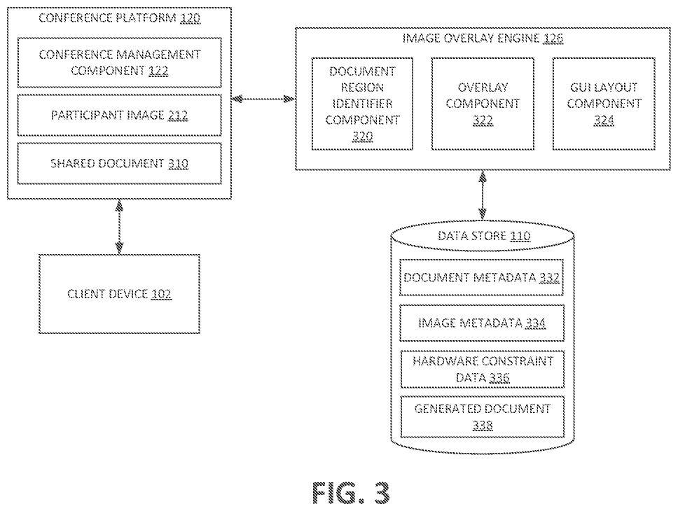

Conference platform 120 can also include an image overlay engine 126 that is configured to overlay the image depicting the presenter with the document shared with the participants of the conference call. In some embodiments, image overlay engine 126 can identify one or more regions of the document that satisfy one or more image placement criteria and can cause the image depicting the presenter to be presented at one of the identified regions. For example, a region of the document can satisfy an image placement criteria if the region does not include any content (e.g., is a blank space). Image overlay engine 126 can identify one or more regions that do not include any content and can select one of the identified one or more regions to include the image depicting the presenter. In another example, image overlay engine 126 may not identify any regions of the document that satisfy an image placement criteria. In such embodiments, image overlay engine 126 can modify a size, a shape, and/or a transparency of the image depicting the presenter and can cause the modified image depicting the presenter to be overlayed with the document, in accordance with embodiment described herein. Further details regarding image overlay engine 126 are provided with respect to FIG. 3.

In response to image overlay engine 126 identifying a region to include the image (or modified image) depicting the presenter, conference management component 122 can provide the document and the image depicting the presenter for presentation via a conference platform GUI on client devices associated with the other participants of the call. The image depicting the presenter can be included at the region of the document identified by the image overlay engine 126. In some embodiments, conference management component 122 can receive a request from the client device 102 associated with the presenter to move the image depicting the presenter from the identified region to another region of the document. In such embodiments, conference management component 122 can move the image depicting the presenter to another region of the document, in accordance with the request. In some embodiments, the requested region of the document can include one or more content items. Conference management platform 122 can modify the image depicting the presenter and/or a formatting or orientation of the one or more content items in view of the image, in some embodiments. Further details regarding conference management component 122 modifying the image depicting the presenter and/or the content items of the document are provided herein.

As described above, in some embodiments system architecture can include a predictive system 112 that includes one or more server machines 130-150. In some embodiments, background extraction engine 124, described above, can be part of predictive system 112. In such embodiments, predictive system 112 can be configured to train an image extraction model that can be used by background extraction engine 124 to identify a portion of an image that corresponds to a conference call participant and a portion of the image that corresponds to an environment surrounding the conference call participant. In additional or alternative embodiments, predictive system 112 can include a gesture detection engine 151. In such embodiments, predictive system 112 can be configured to train a gesture detection model that can be used by gesture detection engine 151 to detect a gesture made by a conference call participant during a conference call and generate a GUI element that corresponds to the detected gesture for presentation at the conference platform GUI at the client devices 102 associated with other participants of the conference call. Further details regarding the image extraction model and the gesture detection model are provided herein.

Predictive system 112 can include at least a training set generator 131, a training engine 141 and one or more machine learning models 160A-N. In some embodiments, predictive system 112 can also include background extraction engine 124 and/or gesture detection engine 151, as described above. Server machine 130 can include a training set generator 131 that is capable of generating training data (e.g., a set of training inputs and a set of target outputs) to train ML models 160A-N. For the image extraction model, training data can be generated based on images that have been previously captured by audiovisual components of client devices associated with participants of prior conference calls hosted by conference platform 120. For example, during a prior conference call, an audiovisual component (e.g., a camera) of a client device associated with a conference call participant can generate an image depicting the conference call participant and the environment surrounding the conference call participant. In some embodiments, the conference call participant can provide an indication (e.g., via the conference platform GUI at the client device) of a portion of the image that depicts the conference call participant and/or an indication of the portion of the image that depicts the environment surrounding the conference call participant. The client device can transmit the generated image as well as the one or more indications provided by the conference call participant to conference platform 120 (e.g., via network 108). In response to receiving the generated image and the one or more indications, conference management component 122 (or another component of conference platform 120) can store the received image and indications at data store 110 as training data.

In other or similar embodiments, the conference call participant may not provide the indication of the portion of the image that depicts the conference call participant and/or the indication of the portion of the image that depicts the environment surrounding the conference call participant. In such embodiments, the client device 102 associated with the conference call participant can transmit the generated image to conference platform and conference management component 122 (or another component of conference platform 120) can store the generated image at data store 110. In some embodiments, a client device 102 associated with another user (e.g., a programmer, a developer, an operator, etc.) of conference platform 120 (or another platform connected to platform 120 via network 108 or another network) can obtain the generated image from data store 110. In such embodiments, the other user can provide an indication of the portion of the image that depicts the conference call participant and/or an indication of the portion of the image that depicts the environment surrounding the conference call participant. The client device 102 associated with the other user can transmit the one or more indications to conference platform 120, in accordance with previously described embodiments. Conference management component 122 can store the one or more provided indications with the image as training data at data store 110, as described above.

As described above, the image generated by the client device 102 associated with a conference call participant can depict an image of the participant during a prior conference call hosted by conference platform 120, in some embodiments. In other or similar embodiments, the image generated by the client device 102 can depict an image of the participant just before a conference call that is going to be hosted by conference platform 120. For example, the conference call participant can be a presenter for the conference call and can prepare one or more documents that are to be shared during the conference call, in accordance with embodiments described herein. Before the conference call, the conference call presenter can cause an audiovisual component (e.g., a camera) of the client device associated with the presenter to generate one or more images depicting the presenter before the conference call. In some embodiments, the one or more generated images can depict conditions associated with the presenter and/or the environment surrounding the presenter that are expected to be captured by the audiovisual component of the client device during the conference call. For example, the generated images can depict an expected positioning or orientation of the presenter during the conference call, an expected attire of the presenter during the conference call, an expected positioning of one or more objects included in the environment surrounding the presenter during the conference call, an expected lighting condition associated with the presenter and/or the environment surrounding the presenter during the conference call, and so forth. In some embodiments, the client device 102 associated with the presenter can transmit the generated images to conference platform 120, as previously described. In other or similar embodiments, the presenter can provide an indication of a portion of each of the one or more generated images that depicts the presenter and/or an indication of a portion of the one or more generated images that depicts the environment surrounding the presenter via a GUI of the client device, as previously described. In such embodiments, the client device 102 associated with the presenter can transmit the one or more generated images and the one or more provided indications to conference platform 120, as previously described. The one or more generated images and the one or more indications can be stored to data store 110 as training data, as described above.

Training set generator 131 of server machine 130 can obtain the training data from data store 110 and can generate a training set based on the obtained training data. The training set can include a subset of training inputs and target outputs based on the retrieved training data. The subset of training inputs can include image data associated with an image depicting a conference call participant (i.e., generated during prior conference calls or before a conference call), as described above. Training set generator 131 can generate one or more target outputs for each of the subset of training inputs. In some embodiments, training set generator 131 can determine, based on the one or more indications associated with each image of the training data, a set of pixels that correspond to the conference call participant and a set of pixels that correspond to the environment surrounding the conference call participant. A target output for a respective training input of the training set can correspond to at least an indication of the set of pixels that associated with the conference call participant.

Server machine 140 can include a training engine 141. Training engine 141 can train a machine learning model 160A-N using the training data from training set generator 131. The machine learning model 160A-N can refer to the model artifact that is created by the training engine 141 using the training data that includes training inputs and corresponding target outputs (correct answers for respective training inputs). The training engine 141 can find patterns in the training data that map the training input to the target output (the answer to be predicted), and provide the machine learning model 160A-N that captures these patterns. The machine learning model 160A-N can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model can be trained by, for example, adjusting weights of a neural network in accordance with a backpropagation learning algorithm or the like. For convenience, the remainder of this disclosure will refer to the implementation as a neural network, even though some implementations might employ an SVM or other type of learning machine instead of, or in addition to, a neural network. In one aspect, the training set is obtained by training set generator 131 hosted by server machine 130.

Background extraction engine 124 of server 150 can provide image data associated with one or more images generated by an audiovisual component (e.g., a camera) of a client device 102 associated with a participant (e.g., a presenter) of a current conference call as input to the trained machine learning model 160 to obtain one or more outputs. In some embodiments, the provided image data can be associated with images that depict the conference call presenter in the same or similar conditions as associated with one or more images that were used to train machine learning model 160, as described above. The model 160 can be used to determine a likelihood that each pixel of the provided image data corresponds to the participant of the current conference call or an environment surrounding the conference call participant. In some embodiments, the one or more outputs of the model 160 can include data indicating a level of confidence that one or more pixels of the image data corresponds to the conference call participant (or the environment surrounding the conference call participant). In response to determining that the level of confidence associated with the one or more pixels of the image data satisfy a confidence criterion (e.g., meets or exceeds a threshold level of confidence), background extraction engine 124 can determine that the one or more pixels correspond to a view of the conference call participant and can extract the image depicting the conference call participant from the provided image data, in accordance with embodiments provided herein (e.g., with respect to FIG. 2).

As described above, in some embodiments, predictive system 112 can be configured to train a gesture detection model that is used by gesture detection engine 151 to detect a gesture made by a conference call participant during a conference call hosted by conference platform 120. In some embodiments, training set generator 131 can be capable of generating training data to train the gesture detection model based on image and/or video data that have been previously captured by audiovisual components of client devices associated with participants of prior conference calls hosted by conference platform 120. For example, during a prior conference call, an audiovisual component (e.g., a camera) of a client device 102 associated with a conference call participant can generate a video depicting the conference call participant providing a gesture (e.g., with his or her hands, with an object such as a pen or a laser pointer, etc.). In some embodiments the conference call participant can provide (e.g., during or after the conference call) an indication of whether the gesture was directed to one or more content items displayed in a document presented via a conference platform GUI of the client device 102. In additional or alternative embodiments, the conference call participant can provide another indication of the one or more content items of the presented document that were the focus of the provided gesture. The conference call participant can provide the one or more indications associated with the gesture and/or the content items of the presented document via the conference platform GUI at the client device 102, in some embodiments. Responsive to receiving the one or more indications via the conference platform GUI, the client device 102 can transmit video data associated with the generated video and the one or more indications to conference platform 120, in accordance with previously described embodiments. In some embodiments, client device 102 can also transmit one or more portions of the document was presented via the conference platform GUI at the time the video depicting the gesture was captured. Conference management component 122 (or another component of conference platform 120) can store the received video data, the one or more indications, and or the document as training data at data store 110, as described above.

Training set generator 131 of server machine 130 can obtain the training data from data store 110 and can generate a training set based on the obtained training data, as described above. The training set can include a subset of training inputs and target outputs based on the obtained training data. The subset of training inputs can include video data associated with a video depicting a gesture provided by a conference call participant. In some embodiments, the subset of training inputs can also include the document that was presented via the conference platform GUI at the time the video depicting the gesture was captured. Training set generator 131 can generate one or more target outputs for each of the subset of training inputs. In some embodiments, training set generator 131 can determine, based on the one or more indications associated with a respective video data of the training data, whether a gesture depicted in a video captured by a client device 102 was made towards one or more content items of a document presented via the conference platform GUI of the client device 102 and can generate a target output based on this determination. In other or similar embodiments, training set generator 131 can determine one or more content items of the document that were the subject of the gesture based on the one or more indications associated with the respective video. Training set generator 131 can generate an additional target output indicating the determined one or more content items.

Training engine 141 can train a machine learning model 160A-N using the training data from training set generator 131, in accordance with previously described embodiments. Gesture detection engine 151 can provide video data associated with one or more videos generated by an audiovisual component (e.g., a camera) of a client device associated with a participant (e.g., a presenter) of a current conference call as input to the trained machine learning model 160 to obtain one or more outputs. The model 160 can determine a likelihood that a gesture depicted in the video associated with the video data is directed to one or more content items of a document currently displayed via a conference platform GUI of client devices associated with one or more participants of the current conference call. For example, the one or more outputs of the model 160 can provide a level of confidence that a gesture depicted in the video is directed to a respective content item included in the document. Responsive to determining that the level of confidence exceeds a threshold level of confidence, gesture detection engine 151 can determine that the participant of the conference call was likely gesturing to the respective content item. Gesture detection engine 151 can generate a GUI element (or transmit an instruction to client devices associated with the one or more participants of the conference call to generate the GUI element) that highlights the respective content item that is gestured to by the conference call participant. The gesture detection engine 151 can update the conference platform GUI at each client device associated with a conference platform participant to include the generated GUI element.

In some implementations, conference platform 120 and/or server machines 130-150 can operate on one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to enable a user to connect with other users via a conference call. In some implementations, the functions of conference platform 120 may be provided by a more than one machine. For example, in some implementations, the functions of conference management component 122, background extraction engine 124, and image overlay engine 126 may be provided by two or more separate server machines. Conference platform 120 may also include a website (e.g., a webpage) or application back-end software that may be used to enable a user to connect with other users via the conference call.

It should be noted that in some other implementations, the functions of server machines 130, 140, and 150 or conference platform 120 can be provided by a fewer number of machines. For example, in some implementations server machines 130 and 140 can be integrated into a single machine, while in other implementations server machines 130, 140, and 150 can be integrated into multiple machines. In addition, in some implementations one or more of server machines 130, 140, and 150 can be integrated into conference platform 120.

In general, functions described in implementations as being performed by conference platform 120 can also be performed on the client devices 102A-N in other implementations, if appropriate. In addition, the functionality attributed to a particular component can be performed by different or multiple components operating together. Conference platform 120 can also be accessed as a service provided to other systems or devices through appropriate application programming interfaces, and thus is not limited to use in websites.

Although implementations of the disclosure are discussed in terms of conference platform 120 and users of conference platform 120 participating in a video and/or audio conference call, implementations can also be generally applied to any type of telephone call or conference call between users. Implementations of the disclosure are not limited to content sharing platforms that provide conference call tools to users.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline, such as a topic channel, of the conference platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram illustrating a conference platform 120 and a background extraction engine 124 for the conference platform 120, in accordance with implementations of the present disclosure. As described with respect to FIG. 1, conference platform 120 can provide tools to users of a client device 102 to join and participate in a video and/or audio conference call. Conference platform 120 can include a conference management component 122. As also described with respect to FIG. 1, background extraction engine 124 can be configured to extract an image depicting a participant (e.g., a presenter) of a conference call from an image corresponding to a view of the participant in a surrounding environment. In some embodiments, background extraction engine 124 can be included as a component of conference platform 120. In other or similar embodiments, background extraction engine can be separate from conference platform 120, as illustrated in FIG. 2. For example, background extraction engine 124 can reside on one or more server machines that are separate from one or more server machines associated with conference platform 120. In another example, background extraction engine 124 can be communicatively coupled to multiple platforms (e.g., conference platform 120, a content sharing platform, a document sharing platform etc.) via one or more networks. In such example, background extraction engine 124 can be configured to extract images of users such platforms from image data, in accordance with embodiments described herein.

Background extraction engine 124 can include at least an extraction component 220 and an image generation component 222, in some embodiments. As described with respect to FIG. 1, an audiovisual component of a client device 102 can capture images and generate image data 210 associated with the captured images. In some embodiments, the generated image data 210 can include two or more sets of pixels that each correspond to different portions of a view depicted in the captured images. For example, a first set of pixels can correspond to a portion of the view depicted in the captured images associated with a participant of a conference call hosted by conference platform 120. A second set of pixels can correspond to a portion of the view associated with an environment surrounding the participant, also referred to as a background of the participant. Client device 102 can transmit the generated image data 210 associated with the captured images to conference platform 120 (e.g., during a conference call with one or more additional users of conference platform 120). Responsive to receiving the image data from client device 102, conference platform 120 can provide the received image data 210 to background extraction engine 124. Background extraction engine 124 can store the received image data 210 at a memory (e.g., data store 110) associated with background extraction engine 124 and/or conference platform 120, in some embodiments.

Extraction component 220 of background extraction engine 124 can be configured to obtain an image depicting a participant of a conference call (referred to as participant image 212 herein) from image data 210 generated by client device 102. As described above, image data can include a first set of pixels that correspond to a view of the participant of the conference call and a second set of pixels that correspond to a view of an environment surrounding the participant. In some embodiments, extraction component 220 can parse through image data 210 to identify the first set of pixels and the second set of pixels. For example, in some embodiments, the participant of the conference call can provide an indication of a first portion of a generated image that corresponds to the participant and a second portion of the generated image that corresponds to the surrounding environment (e.g., by drawing an outline of a silhouette of the participant using an element of the conference platform GUI). Extraction component 220 can identify, in view of the indication provided by the conference call participant, the first set of pixels that are associated with the first portion of the generated image and the second set of pixels that are associated with the second portion of the generated image. In another example, the pixels of image data 210 that correspond to the environment surrounding the conference call participant can be associated with a distinct color that is different from any color associated with the pixels of image data 210 that correspond to the conference call participant (e.g., if the conference call participant is sitting or standing in front of a green screen). Extraction component 220 can determine that each pixel of image data 210 that is associated with the distinct color is included in the second set of pixels corresponding to the surrounding environment and each pixel of image data 210 that is not associated with the distinct color is included in the first set of pixels corresponding to the conference call participant.

In other or similar embodiments, extraction component 220 can identify the first set of pixels and the second set of pixels of image data 210 based on an output of a trained image extraction model 234. In some embodiments, trained image extraction model 234 can be a machine learning model that is trained to determine a likelihood that each pixel of image data 210 corresponds to the conference call participant or an environment surrounding the conference call participant. In some embodiments, trained image extraction model 234 can be trained by predictive system 112, in accordance with embodiments described with respect to FIG. 1. Extraction component 220 can provide the image data 210 generated by client device 102 as input to the trained image extraction model 234 and obtain one or more outputs of the trained image extraction model 234. In some embodiments, the one or more obtained outputs can include data indicating a level of confidence that one or more pixels of image data 210 correspond to the conference call participant (or the environment surrounding the conference call participant). In response to determining that the level of confidence associated with the one or more pixels of image data 210 satisfy a confidence criterion (e.g., meets or exceeds a threshold level of confidence), extraction component 220 can determine that the one or more pixels are included in the first set of pixels corresponding to the view of the conference call participant. In response to determining that the level of confidence associated with the one or more pixels does not satisfy the confidence criterion (e.g., falls below the threshold level of confidence), extraction component 220 can determine that the one or more pixels are included in the second set of pixels corresponding to the view of the environment surrounding the conference call participant.

In response to identifying the first set of pixels from image data 210, extraction component 220 can extract the first set of pixels and store the extracted pixels 232 at data store 110. Image generation component 222 of background extraction engine 124 can generate the participant image 212 based on the extracted pixels 232, in some embodiments. In response to image generation component 222 generating the participant image 212, background extraction engine 124 can transmit the generated participant image 212 to conference management component 122 to be overlaid with the shared document, in accordance with embodiments described herein.

FIG. 3 is a block diagram illustrating an example conference platform 120 and an example image overlay engine 126 for the conference platform 120, in accordance with implementations of the present disclosure. As described with respect to FIG. 1, conference management component 122 can enable a conference call participant to share a document displayed via a GUI on a client device associated with the conference call participant with other participants of the conference call. For example, a presenter for a conference call can prepare a slide presentation document to share with the participants during the conference call. A conference platform GUI provided to the client device 102 associated with the presenter can include one or more GUI elements that enable the presenter to initiate a document sharing operation to share the document with the conference platform participants. Client device 102 can transmit a request to initiate the document sharing operation to conference platform 120 in response to detecting that the presenter has engaged (e.g., clicked on) the one or more GUI elements.

Conference management component 122 of conference platform 120 can receive the request to initiate the document sharing operation from client device 102. In some embodiments, conference management component 122 can also receive an image depicting the document 310 (or a portion of the document) that is to be shared with the other participants of the conference call. In other or similar embodiments, conference management component 122 can receive an identifier for a document 310 that is stored in a data store associated with a document sharing platform that is communicatively coupled to the conference platform 120. In such embodiments, conference management component 122 can retrieve the document 310 from the data store (e.g., in response to determining that the presenter is permitted to access the document 310 from the data store). In some embodiments, conference management component 122 can also receive image data 210 generated by client device 102. Conference management 122 can obtain the image depicting the presenter based on the received image data 210 (e.g., by providing the image data 210 to background extraction engine 124), in accordance with embodiments described with respect to FIG. 2.

Responsive to receiving the participant image 212 and shared document 310, conference management component 122 can provide the participant image 212 and shared document 310 to image overlay engine 126. As described with respect to FIG. 1, image overlay engine 126 can be configured to overlay participant image 212 with shared document 310. In some embodiments, image overlay engine 126 can be included as a component of conference platform 120. In other or similar embodiments, image overlay engine 126 can be separate from conference platform 120, as illustrated in FIG. 2. For example, image overlay engine 126 can reside on one or more server machines that are separate from one or more server machines associated with conference platform 120.

Image overlay engine 126 can include at least a document region identifier component 320, a GUI layout component 322, and an overlay component 324. In response to image overlay engine 126 receiving shared document 310 from conference management component 122, document region identifier component 320 can identify one or more regions of shared document 310 that satisfy one or more image placement criteria associated with shared document 310. The one or more image placement criteria correspond to a set of characteristics associated with a target region of shared document 310 for image placement. For example, a region of shared document 310 can satisfy an image placement criterion if the region does not include any content (e.g., is a blank space). Such region is referred to as a blank region of document 310, in some embodiments. In another example, a region of shared document 310 can satisfy another image placement criterion if the region includes one or more content items that can be modified in order to accommodate presenter image 212. In some embodiments, the set of characteristics associated with the target region of shared document 310 can be defined by the participant that has requested to share document 310 with other participants of the conference call (i.e., the conference call presenter). In other or similar embodiments, the set of characteristics can be determined by conference platform 120 in view of testing and/or run-time data collected for one or more conference calls at one or more client devices 102 connected to conference platform 120. Further details associated with the one or more image placement criteria are provided herein.

In some embodiments, document region identifier component 320 can identify one or more regions that satisfy the one or more image placement criteria based on metadata 332 associated with the document and/or metadata 334 associated with participant image 212. Document metadata 332 can include data associated with characteristics of one or more regions of shared document 310. For example, in some embodiments, client device 102 can transmit an image depicting the shared document 310 with the request to share document 310 with other participants of the conference call. Client device 102 can also include document metadata 332, which includes pixel data associated with one or more regions of shared document 310. In some embodiments, the pixel data can indicate a color associated with one or more pixels of the image depicting shared document 310. In some embodiments, image metadata 334 can include data associated with characteristics of one or more portions of participant image 212. For example, image metadata 334 can include data associated with a size of participant image 212, a shape of participant image 212, and/or pixel data associated with the one or more portions of participant image 212.

Document region identifier component 320 can identify a region that satisfies the one or more image placement criteria in view of document metadata 332 and/or image metadata 334. In some embodiments, document region identifier component 320 can determine the size of participant image 212 and/or the shape of participant image 212 based on image metadata 334. Document region identifier component 320 can also determine an image boundary associated with participant 212 in view of the determined size and/or shape of participant image 212. In some embodiments, the determined image boundary can correspond to a maximum and/or minimum size associated with participant image 212 at a region of shared document 310. The determined image boundary can also correspond to a target shape associated with participant image 212 at a region of shared document 310. For example, document region identifier component 320 can determine, in view of the determined size and/or shape of participant image 212, that a target shape associated with participant image 212 corresponds to a square shape.

In some embodiments, document region identifier component 320 can parse through pixel data included in document metadata 332 to identify a region of shared document 310 that does not include any content. For example, document region identifier 320 can determine, based on document metadata 332, that pixels corresponding to text content items of shared document 310 are associated with the color black and pixels corresponding to a background of shared document 310 are associated with the color white. Document region identifier 320 can parse through pixel data included in document metadata 332 to determine regions of shared document 310 that include pixels that are associated with the color white (i.e., regions that do not include any text content items). In response to determining regions of shared document 310 that include pixels that are associated with the color white, document region identifier component 320 can determine whether a size and/or shape of each respective region corresponds to the size and/or shape associated with participant image 212. For example, document region identifier component 320 can determine whether the size of a respective region is the same as or is larger than the size associated with participant image 212. In response to determining that the size of a respective region of shared document 310 corresponds to the size and/or shape associated with participant image 212, document region identifier can determine that the respective region satisfies the one or more image placement criteria.

In some embodiments, document region identifier component 320 can determine whether a region of shared document 310 satisfies the one or more image placement criteria in view of the pixel data associated with participant image 212. For example, in some embodiments, the pixel data associated with participant image 212 can include an indication of a color associated with one or more pixels of participant image 212. In response to identifying a region of shared document 310 that corresponds to a size and/or shape associated with participant image 212, document region identifier component 320 can determine whether a color associated with the pixels for the identified region corresponds to a color associated with pixels for participant image 212. In response to determining that the color associated with pixels for the identified region does not correspond to a color associated with pixels for participant image 212, document region identifier component 320 can determine that the one or more image placement criteria are satisfied. In response to determining that the color associated with the pixels for participant image 212 correspond to a color associated with pixels for participant image 212, document region identifier component 320 can determine that the one or more image placement criteria are not satisfied.

In some embodiments, document region identifier component 320 can identify multiple regions of shared document 310 that satisfy the one or more image placement criteria. In such embodiments, document region identifier component 320 can determine a region for presentation of participant image 212 image placement conditions associated with shared document 310. An image placement condition can be a pre-defined set of conditions associated with presenting participant image 212 with shared document 310. In some embodiments, the image placement conditions can be defined by the participant that is requesting to share document 310 with other participants of the conference call. For example, before or during the conference call, the participant can provide (i.e., via a GUI of a client device associated with the participant) an indication of a target image region for each document shared with other conference call participants. In response to determining that the target image region corresponds to a region determine to satisfy the one or more image placement criteria, document region identifier component 320 can select the target image region for placement of participant image 212.

In some embodiments, document region identifier component 320 can determine that no region of shared document 310 satisfies the one or more image placement criteria. For example, document region identifier component 320 can determine that no blank region of shared document 310 corresponds to a size and/or shape associated with participant image 212. In such example, document region identifier component 320 can determine whether a size and/or shape of participant image 212 can be modified for presentation with shared document 310. For example, in response to determining that no blank region of shared document 310 corresponds to an image boundary associated with participant image 212, document region identifier component 320 can determine whether a size and/or shape of participant image 212 can be modified to fit within a blank region of shared document 310, in view of the maximum and/or minimum size associated with participant image 212. In response to determining that the size and/or the shape can be modified (e.g., the size of participant image 212 can be made smaller) to fit within a blank region of shared document 310, document region identifier component 320 can modify the size and/or shape of shared document 310 select region of shared document 310 for placement of modified participant image 212.

In another example, document region identifier component 320 can determine that a size of participant image 212 cannot be modified to fit within a blank region of shared document 310. In such embodiments, document region identifier component 320 can determine whether participant image 212 can be placed over top of content at any region of shared document 310. For example, in some embodiments, a respective region of shared document 310 can include a logo of a company or an entity associated with one or more participants of the conference call. In response to determining that the respective region of shared document 310 corresponds to the image boundary associated with participant image 212, document region identifier component 320 can select the respective region for placement of participant image 212.

In another example, document region identifier component 320 can determine that no pixels for any blank region of shared document 310 are associated with a color that is different from a color associated with pixels for participant image 212. In such example, document region identifier component 320 can determine whether one or more pixels for participant image 212 can be modified to be associated with a different color than the pixels for the blank region of shared document 310. For example, document region identifier component 320 can determine that a color temperature associated with the one or more pixels for participant image 212 can be modified (e.g., increased or decreased) such to cause the pixels for participant image 212 to be associated with a different color. In some embodiments, by modifying the color temperature associated with the one or more pixels for participant image 212, the color associated with the one or more pixels for participant image 212 can be different from the color associated with the pixels for the blank region of shared documents 310. In response to modifying the color temperature associated with the one or more pixels for participant image 212, document region identifier component 320 can select the blank region of shared document 310 for placement of modified participant image 212.

In yet another example, document region identifier component 320 can determine that the size, shape, and/or color associated with pixels of participant image 212 cannot be modified to fit within a blank region of shared document 310. In such examples, document region identifier component 320 can identify a region of shared document 310 that corresponds to the image boundary for participant image 212 and includes the smallest number of content items than other regions of shared document 310. In some embodiments, document region identifier component 320 can additionally modify a transparency of participant image 212 such that the content items at the identified region are detectable by the other participants of the conference call while participant image 212 is presented at the identified region.

As described above, in some embodiments, the request to initiate the document sharing operation can include an identifier for a document 310 that is stored in a data store associated with a document sharing platform that is communicatively coupled to conference platform 120. In such embodiments, document region identifier component 320 can identify a region based on metadata 332 associated with the stored document and/or image metadata 334, as described above. For example, in such embodiments, document metadata 332 can include metadata associated with one or more content items included in document 310. The metadata associated with one or more content items can include an indication of a style associated with the one or more content items (e.g., a bold style, an italic style, an underlined style, etc.), a formatting associated with the one or more content items (e.g., a size of the content item), and/or an orientation of the one or more content items within the document 310 (i.e., a positioning of the content items relative to one or more other content items of the document 310). Document region identifier component 320 can determine whether any regions of document 310 correspond to the size and/or shape associated with participant image 212, in accordance with previously described embodiments. In response to determining that no regions of document 310 correspond to the size and/or shape associated with participant image 212, document region identifier component 320 can determine whether any region of document 310 includes one or more content items that can be modified in order to accommodate participant image 212. For example, a content item of document 310 can correspond to a title associated with a slide of a slide presentation document. Document region identifier component 320 can obtain a style, a formatting and/or an orientation associated with the title based on document metadata 332. In response to obtaining the style, formatting, and/or orientation associated with the title, document region identifier component 320 can determine whether the size, formatting, and/or orientation associated with the title can be modified to accommodate participant image 212. In response to determining that, e.g., the formatting of the title can be modified to accommodate participant image 212, document region identifier can modify the title to accommodate participant image 212 and can select the region associated with the modified title for presentation of participant image 212.

In response to document region identifier component 320 identifying a region of shared document 310 for presentation of participant image 212, overlay component 322 can overlay participant image 212 for presentation at the identified region. In some embodiments, overlay component 322 can generate a rendering of participant image 212 at the identified region of shared document 310 and can transmit the rendering to conference platform 120. In response to receiving the rendering from overlay component 322, conference management component 122 can transmit the rendering to each client device 102 associated with a participant of the conference call, in accordance with embodiments described herein. In other or similar embodiments, overlay component 322 can generate one or more instructions for rendering participant image 212 at the identified region of document 310 and can transmit the generated instructions to conference platform 120. In some embodiments, conference management component 122 can execute the received instructions to generate the rendering of participant image 212 at the identified region of document 310. In other or similar embodiments, conference management component 122 can transmit the received instructions (with or without participant image 212 and/or shared document 310) to each client device 102 associated with a participant of conference call and client device 102 can execute the instructions to generate the rendering of participant image 212 at the identified region of document 310.

As described above, image overlay engine 126 can also include a GUI layout component 322. GUI layout component 324 can be configured to modify the presentation of shared document 310 at a respective client device 102 in view of one or more hardware constraints associated with the client device 102. In an illustrative example, a presenter of a conference call can be associated with client device 102A and a participant of the conference call can be associated with client device 102B. Client device 102A can include a larger display screen than a display screen of a client device 102B. For instance, client device 102A can be a desktop computing device and client device 102B can be a mobile computing device. In such instances, one or more hardware constraints associated with displaying the shared document 310 with participant image 212 at the client device 102B can be different from hardware constraints of the client device associated with client device 102A. In some embodiments, GUI layout component 324 can obtain one or more hardware constraints associated with displaying the shared document 310 with participant image 212 at client device 102B (e.g., by requesting the hardware constraints from client device 102B, in a request from client device 102B to join a conference call hosted by conference platform 120, etc.), and can store the obtained hardware constraints as hardware constraint data 336 at data store 110. In response to determining that the one or more hardware constraints satisfy a hardware constraint criterion, GUI layout component 324 can determine to modify the presentation of shared document 310 at client device 102B. In some embodiments, GUI layout component 324 can determine that a hardware constraint for client device 102B satisfies a hardware constraint criterion in response to determining that a display screen size associated with client device 102B falls below a threshold screen size. In other or similar embodiments, GUI layout component 324 can determine that a hardware constraint for client device 102B satisfies a hardware constraint criterion in response to determining that a display resolution associated with client device 102B falls below a threshold display resolution.

In some embodiments, GUI layout component 324 can modify the presentation of shared document 310 at client device 102B by identifying two or more distinct portions of content at shared document 310. For example, GUI layout component 324 can determine that shared document 310 includes a first portion of content that includes one or more text content items and a second portion of content that includes one or more image content items. In some embodiments, in response to identifying the first and second portions of content at shared document 310, GUI layout component 324 can transmit an instruction to overlay component 322 to display participant image 212 over top of the second portion of content while also displaying the first portion of content at another region of document 310. During the conference call, GUI layout component 324, can detect that the presenter of the conference call has shifted focus from the first portion of content to the second portion of content (i.e., which is blocked by participant image 212). For example, GUI layout component 324 can detect that the presenter has moved a GUI element (e.g., a mouse, a cursor, etc.) of the conference platform GUI to highlight one or more content items at the first portion of content of document 310. In response to detecting that the presenter has shifted focus to the second portion of content, GUI layout component 324 can update the conference platform GUI to display participant image 212 at the region of document 310 that includes the first portion of content while displaying the second portion of content of document 310. In some embodiments, GUI layout component 324 can update the conference platform GUI by generating an instruction that causes overlay component 324 to display participant image 212 over the first portion of content, in accordance with embodiments described herein.

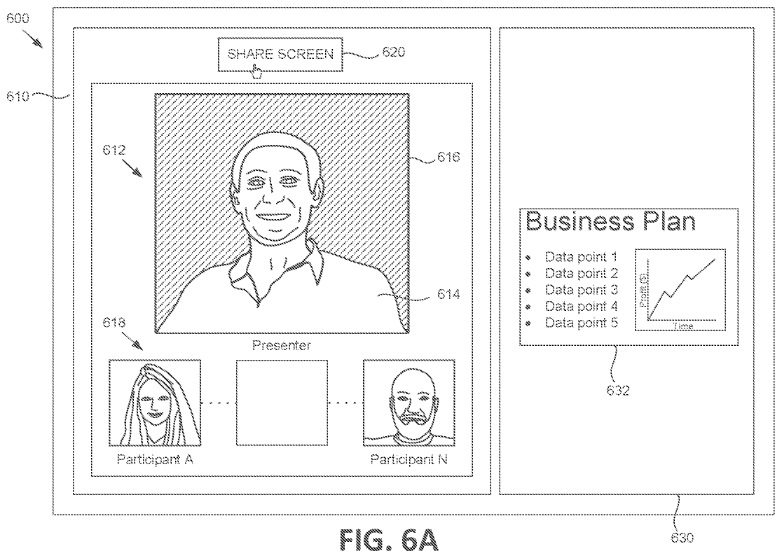

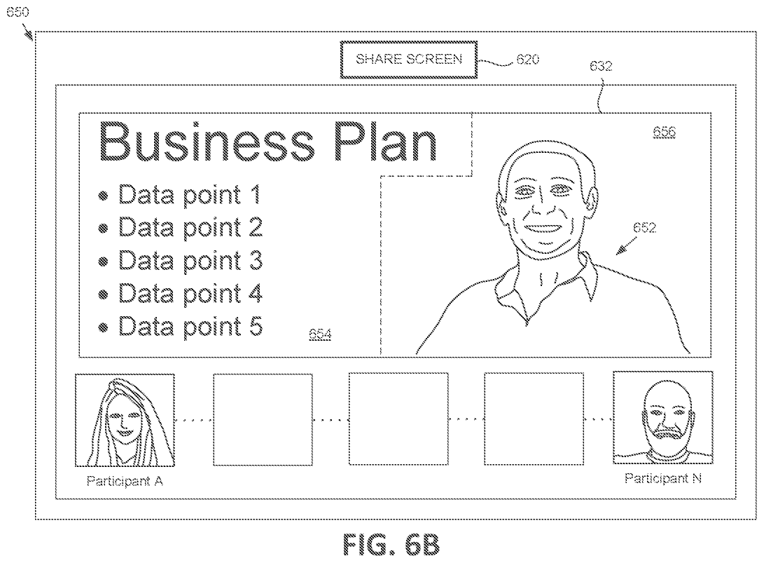

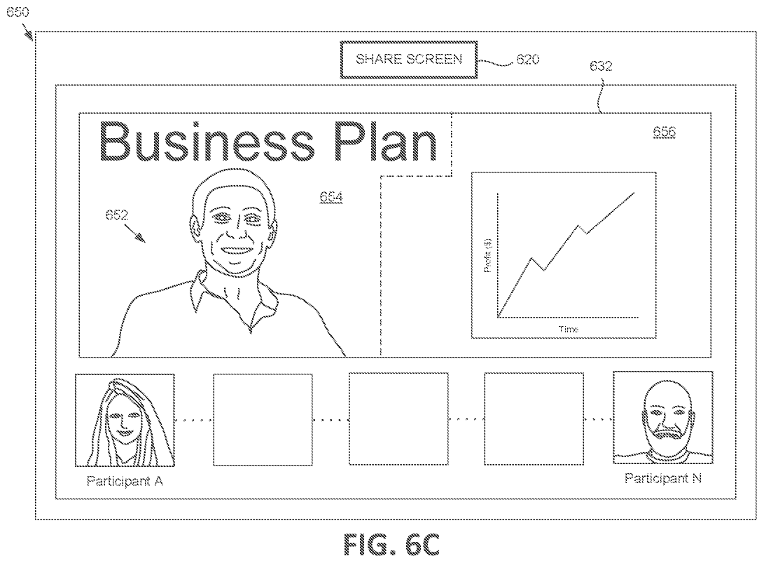

In other or similar embodiments, GUI layout component 324 can generate a new document 338 that includes one or more of the identified distinct portions of content at shared document 310. For example, GUI layout component 324 can select a region including the first portion of content to display with participant image 212. GUI layout component 324 can also generate document 338, which includes one or more similar design characteristics (e.g., style, format, orientation, background, etc.) as shared document 310. Document 338 can further include the second portion of content that is included in shared document 310. In some embodiments, document 338 can also include a blank space (e.g., that corresponds to the region including the first portion of content at shared document 310). During the conference call, overlay component 324 can present participant image 212 at the region of shared document 310 that corresponds to the second portion of content. Responsive to GUI layout component 324 detecting that the presenter has shifted focus to the second portion of content, GUI layout component 324 can update the conference platform GUI to display generated document 338, which includes the second portion of content. Overlay component 324 can also present participant image 212 at the region of generated document 338 that includes the blank space (e.g., that corresponds to the region including the first portion of content at shared document 310). Further details and examples regarding the generation of document 338 are provided with respect to FIGS. 6A-6C.

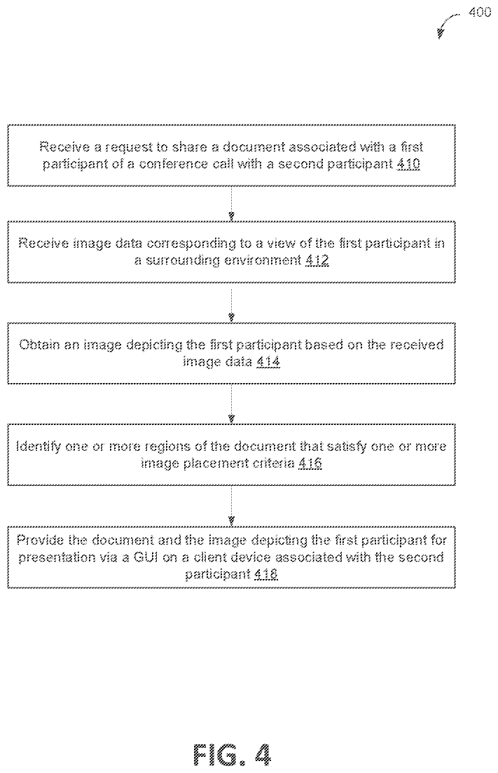

FIG. 4 depicts a flow diagram of an example method 400 for providing a shared document and an image of a conference call participant for presentation via a GUI, in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1.

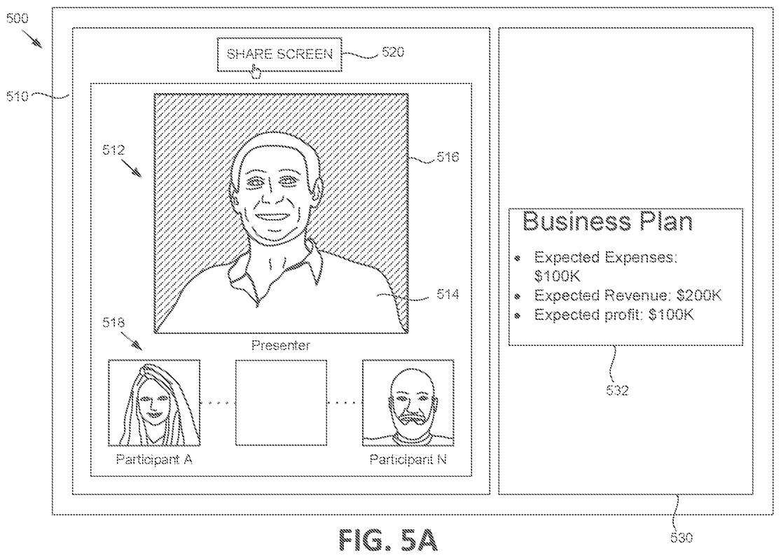

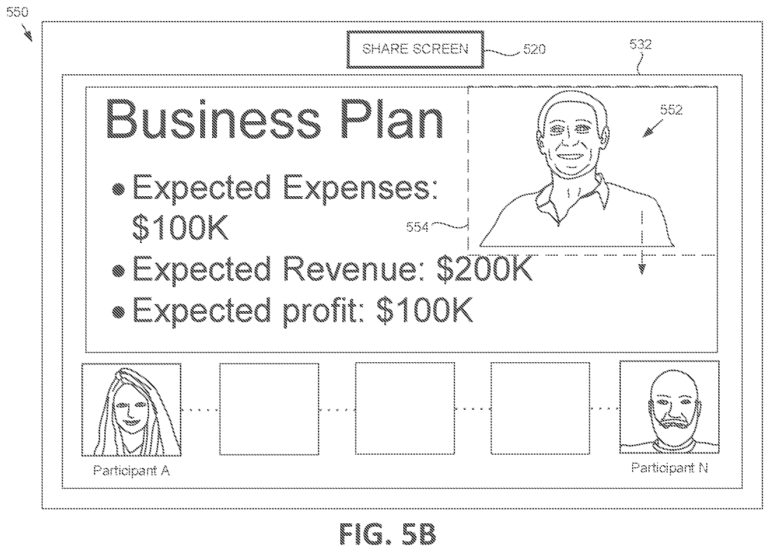

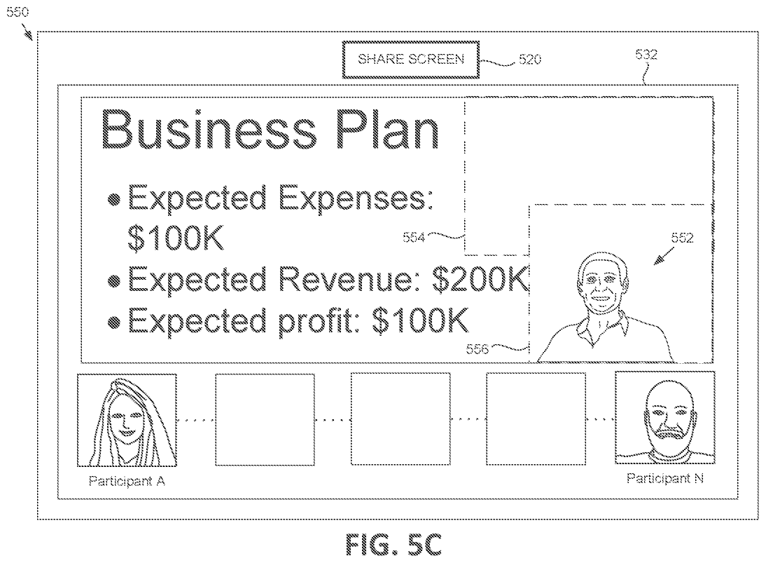

At block 410, processing logic can receive a request to share a document associated with a first participant of a conference call with one or more second participants. In some embodiments, processing logic can receive the request to share the document from a client device associated with a first participant of a conference call. FIG. 5A depicts an example GUI 500 on a client device associated with a first participant (e.g., a presenter) of a conference call, in accordance with implementations of the present disclosure. In some embodiments, GUI 500 can include at least a first portion 510 and a second portion 530. The first portion 510 of GUI 500 can include one or more GUI elements that enable one or more users of conference platform 120 (e.g., the presenter, participants A-N, etc.) to join and participate in the conference call. The second portion 530 of GUI 500 can display a document 532 (e.g., a slide presentation document, a word document, a webpage document, etc.) that is to be shared by a presenter of the conference call with one or more participants of the conference call (e.g., participants A-N). In some embodiments, one or more elements of the first portion 510 of GUI 500 correspond to GUI elements of a conference platform GUI provided by conference management component 122, as described above. In other or similar embodiments, elements of both the first portion 510 and second portion 530 of GUI 500 correspond to elements of the conference platform GUI.

In some embodiments, the first portion 510 of GUI 500 can include a first section 512 and a second section 518 that are both configured to output video data captured at client devices 102 associated with each participant of the conference call. For example, first section 512 can display image data captured by a client device associated with a presenter of a video conference call. Second section 518 can display image data captured by client devices associated with participants of the call. In other or similar embodiments, first portion 510 can include one or more sections that are configured to display image data associated with users of conference platform 120 in other orientations than depicted in FIG. 5A. For example, portion 510 can include a single section that displays image data captured by client devices of the presenter of the conference call and does not display video data captured by client devices of other participants of the conference call. In some embodiments, the image data displayed at the first section 512 and/or the second section 518 of first portion 510 can correspond to a view of a user (e.g., the presenter, participant A-N) in a surrounding environment. As illustrated in FIG. 5A, first section 512 of portion 510 can display image data corresponding to a view of presenter 514 in a surrounding environment 516. In some embodiments, second section 512 of portion 510 can also display image data corresponding to a view of participants A-N in respective surrounding environments (not shown).

The first portion 510 of GUI 500 can also include one or more GUI elements that enable the presenter of the conference call to share document 522 displayed at the second portion 530 with the participants of the conference call. For example, first portion 510 can include a button 520 that enables the presenter to share document 522 displayed at second portion 530 with participants A-N. The presenter can initiate an operation to share document 522 with participants A-N by engaging (e.g., clicking) with button 520. In response to detecting that the presenter has engaged with button 520, the client device associated with the presenter can detect that an operation to share document 532 with participants A-N is to be initiated. The client device can transmit the request to initiate the document sharing operation to conference management component 122, in accordance with previously described embodiments. It should be noted that the presenter can initiate the operation to share document 522 with participants A-N according to other techniques. For example, a setting for the client device associated with the presenter can cause the operation to share document 522 to be initiated in response to detecting that document 522 has been retrieved from local memory of the client device and displayed at the second portion 530 of GUI 500.

Referring back to FIG. 4, at block 412, processing logic can receive image data corresponding to a view of the first participant (e.g., the presenter) in a surrounding environment. As described above, an audiovisual component of the client device associated with the first participant can be configured to capture images of the first participant and generate image data associated with the captured images. The generated image data can be displayed at the first section 512 of the first portion 510 of GUI 500, in according to some embodiments. In response to detecting that the presenter has engaged with button 520 of GUI 500, the client device associated with the first participant can transmit the generated image data displayed at the first section 512 of the first portion 510 of GUI 500 to conference management component 122. The client device associated with the first participant can transmit the generated image data with or separate from the request to initiate the document sharing operation.

At block 414, processing logic can obtain an image depicting the first participant based on the received image data. In response to conference management component 122 receiving the generated image data, conference management component 122 can provide the received image data to background extraction engine 124, in some embodiments. As described previously, background extraction engine 124 can obtain the image depicting the conference call presenter by extracting a set of pixels that corresponds to the conference call presenter and generating the image depicting the conference call presenter based on the extracted set of pixels. In some embodiments, background extraction engine 124 can identify the set of pixels that corresponds to the conference call presenter based on an output of a trained image extraction model, in accordance with previously described embodiments.

At block 416, processing logic can identify one or more regions of the document (e.g., document 522) that satisfy one or more image placement criteria. As described previously, conference management component 122 can receive an image of document 522 to be shared with participants A-N of the conference call from the client device associated with the conference call presenter, in some embodiments. In other or similar embodiments, document 522 can be stored in a data store associated with a document sharing platform that is communicatively coupled to conference platform 120. In such embodiments, conference management component 122 can receive an identifier for document 522 at the data store associated with a document sharing platform. Conference management component 122 can retrieve document 522 (or a portion of document 522) from the data store associated with the document sharing platform, in accordance with previously described embodiments. In response to obtaining at least a portion of document 522 (or the image of the document 522) to be shared with participants A-N, conference management component 122 can provide document 522 to image overlay engine 126, as previously described. Image overlay engine 126 can identify one or more regions of document 522 that satisfy one or more image placement criteria, as described above. For example, image overlay engine 126 can identify one or more blank regions of document 522 that correspond to an image boundary associated with the image of the conference call presenter. In another example, image overlay engine 126 can identify one or more regions of document 522 that include content items that can be modified to accommodate the image of conference call presenter.

At block 418, processing logic can provide the document and the image depicting the first participant for presentation via a GUI on a client device associated with the second participant. As described above, in response to identifying the one or more regions of document 522 that satisfy one or more image placement criteria, image overlay engine 126 can overlay the image of the conference call presenter at one of the identified regions, as described above. For example, image overlay engine 126 can generate a rendering of the image depicting the conference call presenter and the document 522 and provide the generated rendering to conference management component 122. Conference management component 122 can provide the generated rendering to the client devices associated with one or more users of conference platform 120 (e.g., the presenter, participant A-N), in accordance with previously described embodiments. In response to receiving the generated rendering, a client device associated with a respective participant of the conference call (e.g., participant A) can update a GUI to display the rendering of the image depicting the conference call presenter and the document 522. In other or similar embodiments, image overlay engine 126 can generate instructions to render the image depicting the conference call presenter and document 522. Conference management component 122 and/or the client device associated with the respective participant of the conference call can execute the instructions to generate the rendering, in accordance with previously described embodiments.

FIG. 5B depicts an example GUI 550 displaying the rendering of the image depicting the conference call presenter and document 522, in accordance with implementations of the present disclosure. In some embodiments, GUI 550 can be displayed via a client device associated with a participant of the conference call (e.g., participant A). In other or similar embodiments, GUI 550 can be displayed via a client device associated with the presenter of the conference call. As illustrated in FIG. 5B, GUI 550 depicts the document 532 and an image 552 depicting the conference call presenter at a region 554 of document 532. In some embodiments, image overlay engine 126 can select region 554 to include image 552 in response to determining that region 554 satisfies one or more image placement criteria (e.g., includes a blank space that corresponds to an image boundary associated with image 552). The presenter of the conference call can engage with participants A-N by emphasizing one or more content items of document 532 (e.g., by physically pointing to the one or more content items) while image 552 is presented at region 554. In some embodiments, GUI 550 can additionally display image data captured by one or more client devices associated with participants (e.g., participants A-N) of the conference call, as described above.

As described above, in some embodiments, GUI 550 can be displayed via a client device associated with the presenter of the conference call. In such embodiments, the conference call presenter can engage with one or more elements of GUI 550 to modify the presentation of image 552 and document 532, in some embodiments. In an illustrative example, the conference call presenter can request move image 552 from region 554 of document 532 to another region of document 532 (e.g., by clicking image 552 and dragging image 552 to another region of document 532, by pushing one or more buttons on a keyboard connected to the client device). In response to detecting that the conference call presenter has requested to move image 552 to another region of document 532, conference management component 122 can update GUI 550 at each client device associated with the presenter and each participant of the conference call, in accordance with the received request. FIG. 5C depicts an example updated GUI 550, in accordance with implementations of the present disclosure. As illustrated in FIG. 5C, image 552 depicting the conference call presenter has been moved from region 554 of GUI 550 to region 556 of GUI 550. In some embodiments, region 556 can be associated with different characteristics than region 554. For example, a size of region 556 can be smaller than the size of region 554. In such embodiments, conference management component 122 (or image overlay engine 126) can modify a size and/or shape of image 552 to fit within region 556 (e.g., in view of the image boundary associated with image 552).

In some embodiments, conference management component 122 cannot modify a size and/or shape of image 552 to fit within region 556 in view of the image boundary associated with image 552. In such embodiments, conference management component 122 can move image 552 to region 556 in accordance with the request from the conference call presenter. However, in some embodiments, at least a portion of the image 552 can overlap with one or more content items of document 532. In such instance, conference management component 122 can modify a transparency of image 552 such that participants A-N of the conference call can detect the content items of document 532 that overlap with image 552.

FIGS. 6A-6C illustrate another example of overlaying an image of a conference call participant with a shared document for presentation via a GUI, in accordance with implementations of the present disclosure. FIG. 6A depicts another example GUI 600 on a client device associated with a first participant (e.g., a presenter) of a conference call. In some embodiments, GUI 600 can correspond to GUI 500 described with respect to FIG. 5A, except that the document 632 displayed at the second portion 630 of GUI 600 can include one or more additional content items than included in document 532 displayed at the second portion 530 of GUI 500. The conference call presenter can initiate the operation to share document 632 with participants A-N of the conference call (e.g., by engaging with button 620) as described previously.

In response to receiving the request to initiate the document sharing operation, conference management component 122 can transmit the image data generated by the client device associated with the conference call presenter and/or document 632 (or a portion of document 632) to image overlay engine 126. In some embodiments, a client device associated with a participant of the conference call (e.g., participant A) can be subject to different hardware constraints (e.g., display size, display resolution, etc.) than the hardware constraints of the client device associated with the conference call presenter. In such embodiments, image overlay engine 126 can determine to modify the presentation of document 632 and the image depicting the conference call presenter, e.g., in response to determining that the hardware constraints of the client device associated with participant A satisfy a hardware constraint condition. For example, image overlay engine 126 can determine to display a first portion of content of document 632 (e.g., the one or more text content items associated with data points 1-5 of document 632) and the image depicting the conference call presenter at a region including the second portion of content of document 632 (e.g., the one image content item of document 632). In another example, image overlay engine 126 can generate an additional document that includes the second portion of content of document 632, as described previously. In such example, image overlay engine 126 can determine to display the first portion of content of document 632 with the image depicting the conference call presenter at the region associated with the second portion of content of document 632.

FIG. 6B depicts an example GUI 650 displaying the rendering of the image depicting the conference call presenter and document 632, in accordance with implementations of the present disclosure. In some embodiments, GUI 650 can be displayed via a client device associated with a participant of the conference call (e.g., participant A). In other or similar embodiments, GUI 650 can be displayed via a client device associated with the presenter of the conference call. As illustrated in FIG. 6B, GUI 650 displays the content included in the first portion of document 632 in a first region 654 of document 632 and an image 652 depicting the conference call presenter at a second region 656 of document 632. In some embodiments, region 654 is associated with a second portion of content (e.g., the graph included in document 632 illustrated in FIG. 6A) included in document 632. GUI 650 can display image 652 at region 656 associated with the graphic content item, in accordance with previously described embodiments. In some embodiments, conference management component 122 (or image overlay engine 126) can detect that the conference call presenter has shifted focus to the second portion of content included in document 632. For example, conference management component 122 can detect that the conference call presenter has moved a GUI element (e.g., a mouse) at the GUI on the client device associated with the presenter from region 654 of document 632 including the first portion of content to region 656 including the second portion of content. In such embodiments, conference management component 122 (or image overlay engine 126) can update GUI 650 to display the second portion of content of document 632.

FIG. 6C depicts an example updated GUI 650, in accordance with implementations of the present disclosure. In some embodiments, updated GUI 650 displays document 632 with image 622 at region 656. In other or similar embodiments, updated GUI 650 displays the document generated by image overlay engine 126 that includes the second portion of content included in document 632. In such embodiments, updated GUI 650 can display image 622 at region 654 of document 632, in accordance with previously described embodiments.

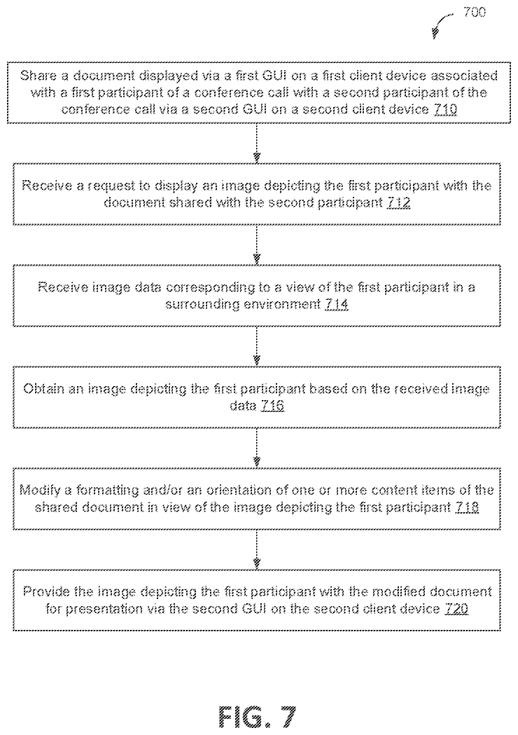

FIG. 7 depicts a flow diagram of another example method 700 for providing a shared document and an image of a conference call participant for presentation via a GUI, in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 700 can be performed by one or more components of system 100 of FIG. 1.

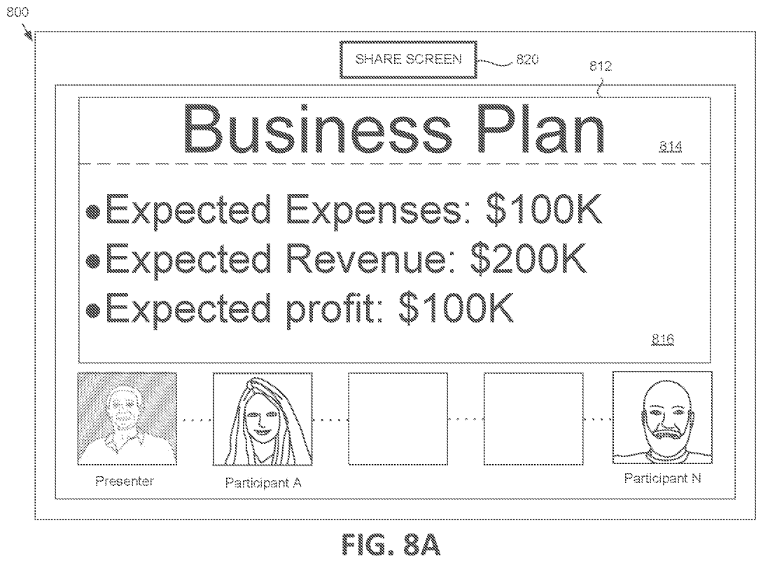

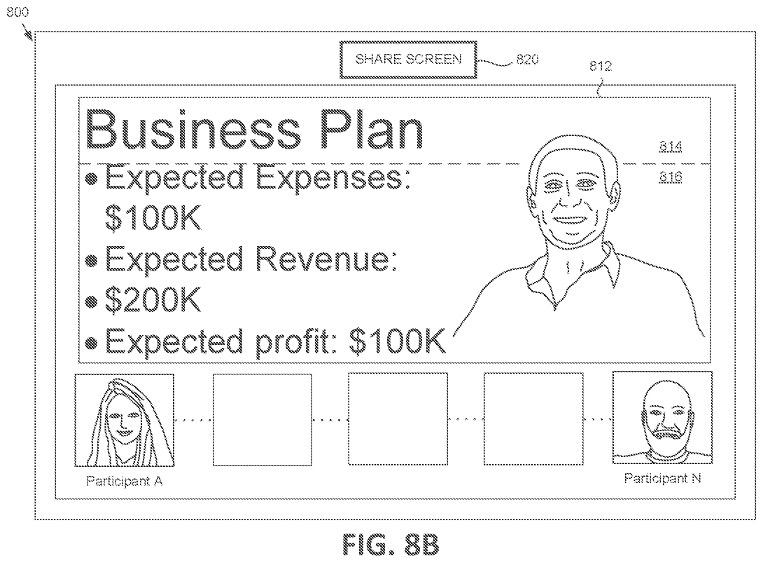

At block 710, processing logic can share a document displayed via a first GUI on a first client device associated with a first participant (e.g., a presenter) of a conference call with a second participant of the conference call via a second GUI on a second client device. FIG. 8A depicts an example GUI 800 displaying a document 812 shared with one or more participants (e.g., Participant A-N) of a conference call, in accordance with implementations of the present disclosure. In some embodiments, GUI 800 can be displayed via a client device associated with a participant of the conference call (e.g., participant A). In other or similar embodiments, GUI 800 can be displayed via a client device associated with the presenter of the conference call. In some embodiments, the presenter of the conference call can share document 812 with the participants of the conference call by engaging with a GUI element (e.g., button 820), in accordance with previously described embodiments. In some embodiments, document 812 can be stored at a data store associated with a document sharing platform communicatively coupled to conference platform 120.

Referring back to FIG. 7, at block 712, processing logic can receive a request to display an image depicting the first participant with the document shared with the second participant. In some embodiments, processing logic can receive the request in response to the conference call presenter engaging with a particular GUI element (not shown) of GUI element 800. At block 714, processing logic can receive image data corresponding to a view of the first participant in a surrounding environment. The client device associated with the conference call presenter can generate image data corresponding to the view of the presenter in the surrounding environment, in accordance with previously described embodiments. Conference management component 122 can receive the generated image data from the client device associated with the conference call presenter, in accordance with previously described embodiments.

At block 716, processing logic can obtain an image depicting the first participant based on the received image data. As previously described, conference management component 122 can provide the received image data to background extraction engine 124. Background extraction engine 124 can generate the image depicting the first participant, in accordance with previously described embodiments. At block 718, processing logic can modify a formatting and/or an orientation of one or more content items of the shared document in view of the image depicting the first participant. As described above, document 812 can be stored at a data store associated with a document sharing platform communicatively coupled to conference platform 120. Content management component 122 can retrieve document 812 from the data store, as previously described. In some embodiments, image overlay engine 126 can identify a region of document 812 that includes one or more content items that can be modified in view of the image depicting the conference call presenter. For example, image overlay engine 126 can identify region 814 of document 812 that includes a title content item. Image overlay engine 126 can determine that a formatting and/or an orientation of the title content item of region 814 can be modified (e.g., in view of metadata associated with document 812) to accommodate the image depicting the conference call presenter. In other example, image overlay engine 126 can determine that a formatting and/or an orientation of one or more text content items can additionally or alternatively be modified to accommodate the image depicting the conference call presenter.

At block 720, processing logic can provide the image depicting the first participant with the modified document for presentation via the second GUI on the second client device. FIG. 8B depicts an updated GUI 800, in accordance with implementations of the present disclosure. As described above, image overlay engine 126 can modify the formatting and/or orientation of the one or more content items at region 814 and/or region 816, in accordance with previously described embodiments. Conference management component 122 can present the modified document 812 via the updated GUI 800, in accordance with previously described embodiments. As illustrated in FIG. 8B, a formatting of the title content item in region 814 of document 812 is modified from an alignment in a center portion of document 812 to an alignment at a left-hand portion of document 812. As also illustrated in FIG. 8B, a size of the one or more text items in region 816 of document 812 has been decreased and an orientation of the one or more text items in region 814 has been modified to accommodate image 822 depicting the conference presenter.

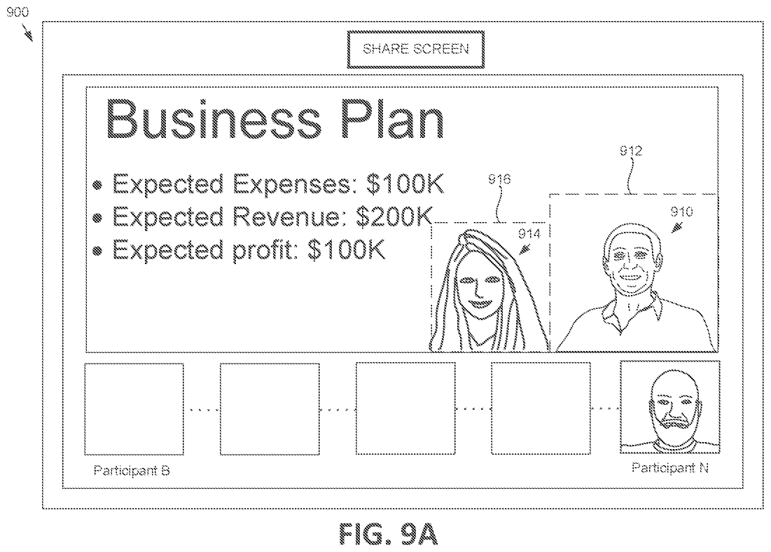

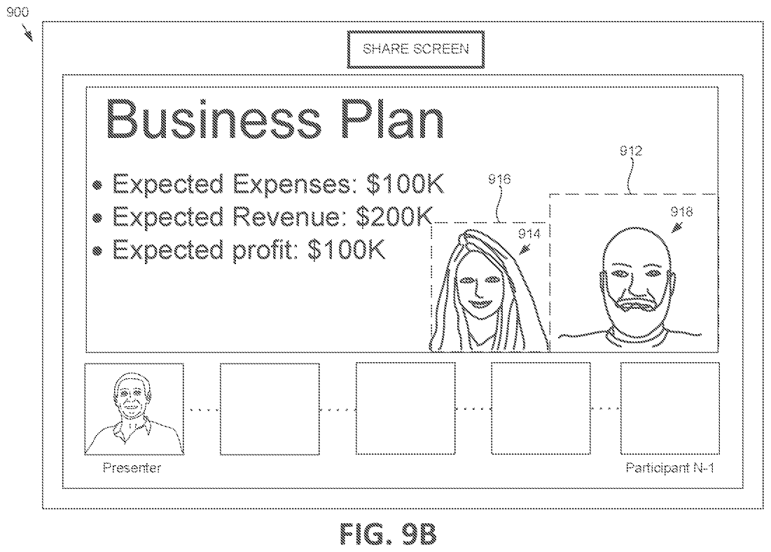

FIGS. 9A-9B illustrate an example of overlaying an image of multiple conference call participants with a shared document for presentation via a GUI 900, in accordance with implementations of the present disclosure. As described above, an image 910 depicting a conference call presenter can be displayed at particular region 912 of a document via a conference platform GUI, in accordance with previously described embodiments. In some embodiments, the conference call presenter can invite an additional participant of the conference call to present a shared document (or a portion of the document) with the conference call presenter. For example, the client device associated with the conference call presenter can transmit a request to the client device associated with the additional participant to present the shared document with the conference call presenter. In response to detecting that the additional conference call presenter has engaged with a GUI element indicating an acceptance of the request, conference management component 122 can initiate a process to display a rendering of an image depicting the additional participant of the conference call with the image depicting the presenter of the conference call.

In one example, conference management component 122 can receive image data generated by an audiovisual component (e.g., a camera) of a client device associated with the additional participant. Conference management component 122 can obtain an image depicting the additional participant, in accordance with previously described embodiments. In some embodiments, conference management component 122 can identify a region of a shared document that satisfies one or more image placement criteria. In some embodiments, conference management component 122 can identify a region that satisfies one or more image placement criteria with respect to the image depicting the additional participant. In other or similar embodiments, conference management component 122 can identify a region that satisfies the one or more image placement criteria with respect to both the image depicting the conference call presenter and the additional participant. In response to identifying a region that satisfies the one or more image placement criteria, conference management component 122 can update a GUI 900 on client devices for each participant of the conference call to display the additional participant (and/or the conference call presenter) at the identified region. As illustrated in FIG. 9A, region 916 can be identified as a region that satisfies one or more image placement criteria. As such, the image 914 depicting the additional participant can be displayed at region 916. In some embodiments, conference management component 122 may not identify a region of the shared document that satisfies the image placement criteria with respect to image 910 depicting the conference call presenter and/or the image 914 depicting the additional participant. In such embodiments, conference management component 122 can modify a format and/or an orientation of one or more content items of the shared document to accommodate the image depicting the conference call presenter and the image depicting the additional participant, in accordance with embodiments described above.

In additional or alternative embodiments, the conference call presenter and/or the additional participant can invite another conference call participant to present the shared document (or a portion of the shared document) in place of the conference call presenter. In such embodiments, conference management component 122 can obtain an image depicting the other conference call participant, as described above. In some embodiments, conference management component 122 can remove the image 910 depicting the conference call presenter from GUI 900 and replace the removed image 910 with the image depicting the other conference call participant, as illustrated in FIG. 9B. In other or similar embodiments, conference management component 122 can identify another region of the shared document that satisfies the one or more image placement criteria and display the image 918 depicting the other conference call participant at the identified region, in accordance with previously described embodiments. In some embodiments, conference management component 122 can modify a format and/or an orientation of one or more content items of the shared document to accommodate image 914 and/or image 918, as previously described.

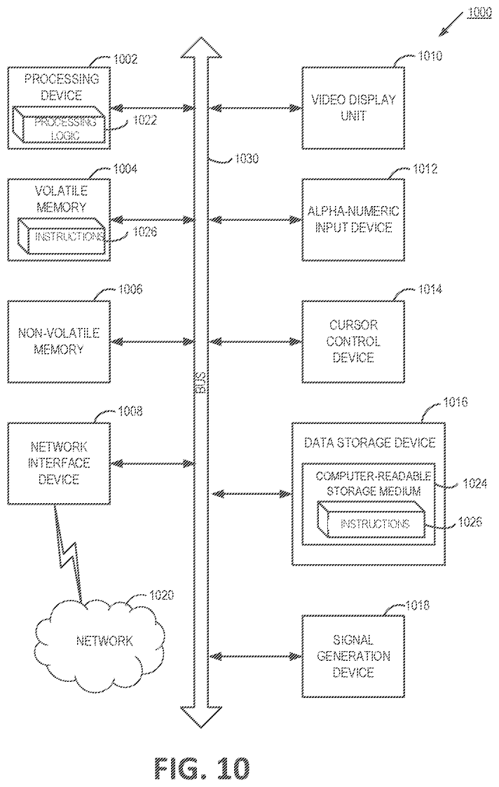

FIG. 10 is a block diagram illustrating an exemplary computer system 1000, in accordance with implementations of the present disclosure. The computer system 1000 can correspond to conference platform 120 and/or client devices 102A-N, described with respect to FIG. 1. Computer system 1000 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1018, which communicate with each other via a bus 1040.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1005 (e.g., for predicting channel lineup viewership) for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1020 (e.g., a speaker).

The data storage device 1018 can include a non-transitory machine-readable storage medium 1024 (also computer-readable storage medium) on which is stored one or more sets of instructions 1005 (e.g., for overlaying an image depicting a conference call presenter with a shared document) embodying any one or more of the methodologies or functions described herein. The instructions can also reside, completely or at least partially, within the main memory 1004 and/or within the processor 1002 during execution thereof by the computer system 1000, the main memory 1004 and the processor 1002 also constituting machine-readable storage media. The instructions can further be transmitted or received over a network 1030 via the network interface device 1008.

In one implementation, the instructions 1005 include instructions for overlaying an image depicting a conference call participant with a shared document. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method performed by a set of processing devices, the method comprising:
receiving a request to initiate a document sharing operation to share a first electronic document displayed via a first graphical user interface (GUI) on a first client device associated with a first participant of a conference call with a second participant of the conference call via a second GUI on a second client device, wherein the first electronic document comprises first content;
feeding at least image data comprising an image depicting the first participant during the conference call as input to a machine learning model;
obtaining, based on one or more outputs of the machine learning model, a second electronic document comprising second content corresponding to the first content, wherein one or more regions of the second electronic document satisfies an image placement criterion; and
providing, during the conference call, the second electronic document and at least a portion of the image data comprising the image depicting the first participant for presentation in at least one of the one or more regions of the second electronic document via the second GUI on the second client device.

2. The method of claim 1, wherein the second electronic document is generated based on the first content and the one or more outputs of the machine learning model.

3. The method of claim 1, wherein the second content comprises one or more portions of the first content.

4. The method of claim 1, wherein the one or more outputs of the machine learning model comprise at least one of a level of confidence that a pixel of the image depicting the first participant corresponds to the first participant, or a level of confidence that the pixel of the image corresponds to an environment surrounding the participant.

5. The method of claim 4, wherein obtaining the second electronic document comprising the second content based on the one or more outputs of the machine learning model comprises:
extracting, from the image data, a set of pixels corresponding to the first participant based on the one or more outputs of the machine learning model;
determining a portion of the first content for inclusion in the second electronic document based on a size of the extracted set of pixels, wherein the second content comprises the determined portion of the first content; and
updating the second electronic document to include an indication of the one or more regions of the electronic document that satisfy the image placement criterion based on the size of the extracted set of pixels and to further include the second content in an additional region of the second electronic document.

6. The method of claim 1, wherein obtaining the second electronic document comprising the second content further comprises:
obtaining data indicating one or more hardware constraints associated with the second client device; and
generating the second electronic document based on the obtained data.

7. The method of claim 1, further comprising:
receiving an additional request to move the image depicting the first participant from the one or more regions of the second electronic document to an additional region of the second electronic document; and
presenting the image depicting the first participant at the additional region of the second electronic document.

8. A system comprising:
a memory device; and
a set of processing devices coupled to the memory device, the set of processing devices to perform operations comprising:
receiving a request to initiate a document sharing operation to share a first electronic document displayed via a first graphical user interface (GUI) on a first client device associated with a first participant of a conference call with a second participant of the conference call via a second GUI on a second client device, wherein the first electronic document comprises first content;
feeding at least image data comprising an image depicting the first participant during the conference call as input to a machine learning model;
obtaining, based on one or more outputs of the machine learning model, a second electronic document comprising second content corresponding to the first content, wherein one or more regions of the second electronic document satisfies an image placement criterion; and
providing, during the conference call, the second electronic document and at least a portion of the image data comprising the image depicting the first participant for presentation in at least one of the one or more regions of the second electronic document via the second GUI on the second client device.

9. The system of claim 8, wherein the second electronic document is generated based on the first content and the one or more outputs of the machine learning model.

10. The system of claim 8, wherein the second content comprises one or more portions of the first content.

11. The system of claim 8, wherein the one or more outputs of the machine learning model comprise at least one of a level of confidence that a pixel of the image depicting the first participant corresponds to the first participant, or a level of confidence that the pixel of the image corresponds to an environment surrounding the participant.

12. The system of claim 11, wherein obtaining the second electronic document comprising the second content based on the one or more outputs of the machine learning model comprises:
extracting, from the image data, a set of pixels corresponding to the first participant based on the one or more outputs of the machine learning model;
determining a portion of the first content for inclusion in the second electronic document based on a size of the extracted set of pixels, wherein the second content comprises the determined portion of the first content; and
updating the second electronic document to include an indication of the one or more regions of the electronic document that satisfy the image placement criterion based on the size of the extracted set of pixels and to further include the second content in an additional region of the second electronic document.

13. The system of claim 8, wherein obtaining the second electronic document comprising the second content further comprises:
obtaining data indicating one or more hardware constraints associated with the second client device; and
generating the second electronic document based on the obtained data.

14. A non-transitory computer readable storage medium comprising instructions for a server that, when executed by a set of processing devices, cause the set of processing devices to perform operations comprising:
receiving a request to initiate a document sharing operation to share a first electronic document displayed via a first graphical user interface (GUI) on a first client device associated with a first participant of a conference call with a second participant of the conference call via a second GUI on a second client device, wherein the first electronic document comprises first content;
feeding at least image data comprising an image depicting the first participant during the conference call as input to a machine learning model;
obtaining, based on one or more outputs of the machine learning model, a second electronic document comprising second content corresponding to the first content, wherein one or more regions of the second electronic document satisfies an image placement criterion; and
providing, during the conference call, the second electronic document and at least a portion of the image data comprising the image depicting the first participant for presentation in at least one of the one or more regions of the second electronic document via the second GUI on the second client device.

15. The non-transitory computer readable storage medium of claim 14, wherein the second electronic document is generated based on the first content and the one or more outputs of the machine learning model.

16. The non-transitory computer readable storage medium of claim 14, wherein the second content comprises one or more portions of the first content.

17. The non-transitory computer readable storage medium of claim 14, wherein the one or more outputs of the machine learning model comprise at least one of a level of confidence that a pixel of the image depicting the first participant corresponds to the first participant, or a level of confidence that the pixel of the image corresponds to an environment surrounding the participant.

18. The non-transitory computer readable storage medium of claim 17, wherein obtaining the second electronic document comprising the second content based on the one or more outputs of the machine learning model comprises:
extracting, from the image data, a set of pixels corresponding to the first participant based on the one or more outputs of the machine learning model;
determining a portion of the first content for inclusion in the second electronic document based on a size of the extracted set of pixels, wherein the second content comprises the determined portion of the first content; and
updating the second electronic document to include an indication of the one or more regions of the electronic document that satisfy the image placement criterion based on the size of the extracted set of pixels and to further include the second content in an additional region of the second electronic document.

19. The non-transitory computer readable storage medium of claim 17, wherein obtaining the second electronic document comprising the second content further comprises:
obtaining data indicating one or more hardware constraints associated with the second client device; and
generating the second electronic document based on the obtained data.

20. The non-transitory computer readable storage medium of claim 17, wherein the operations further comprise:
receiving an additional request to move the image depicting the first participant from the one or more regions of the second electronic document to an additional region of the second electronic document; and
presenting the image depicting the first participant at the additional region of the second electronic document.
